(19) United States
(12) Patent Application Publication
(10) Pub. No.: US 2020/0032010 A1
(43) Pub. Date: Jan. 30, 2020

(54) FIBER REINFORCED POLYMER COMPOSITION

(71) Applicant: DSM IP Assets B.V., Heerlen (NL)

(72) Inventors: Ruogu LIAO, Echt (NL); Frank Peter Theodorus Johannes VAN DER BURGT, Echt (NL)

(21) Appl. No.: 16/495,146

(22) PCT Filed: Mar. 28, 2018
(86) PCT No.: PCT/EP2018/057858

§ 371 Date: Sep. 18, 2019

(30) Foreign Application Priority Data
Mar. 29, 2017 (EP) 17163503.0
Apr. 10, 2017 (CN) PCT/CN2017/079859

(51) Int. Cl. C08J 5/04; C08L 77/06; C08G 63/183; C08K 7/14; C08K 3/40; C08K 3/22; C08K 5/5313; C08K 13/04; C03C 13/00; C03C 3/089; H04M 1/02

(52) U.S. Cl. CPC C08J 5/043; C03C 2213/00; C08G 63/183; C08K 7/14; C08K 3/40; C08K 3/22; C08K 5/5313; C08K 13/04; C03C 13/00; C03C 3/089; H04M 1/0202; C08L 2205/03; C08L 2205/035; C08L 2205/025; C08L 2201/02; C08J 2377/06; C08J 2477/06; C08J 2367/02; C08K 2003/2241; C08L 77/06

(57) ABSTRACT

The invention relates to a fiber reinforced thermoplastic molding composition comprising a thermoplastic polymer and reinforcing fibers, wherein the composition comprises (i) a thermoplastic polymer selected from the group consisting of polyesters, polyamides, polycarbonates, polyphenylene sulphides (PPS), polyphenylene ethers (PPO), polyetheretherketones (PEEK), polyaryletherketones (PAEK), polyamidimides (PAI), polyetherimides (PEI) and liquid crystal polymers (LCPs), and combinations thereof and (ii) silicon-boron glass fibers consisting predominantly of silicon dioxide (SiO₂) and boron trioxide (B₂O₃).

The present invention relates to a composition comprising a thermoplastic polymer and reinforcing fibers, in particular comprising glass fibers as reinforcing fibers. The present invention further relates to the use of the composition as a thermoplastic molding composition, and to applications of the composition in, for example, an electronic mobile device, such as in housings or frames made of a thermoplastic molding composition, or in molded parts for use in electrical components in applications such as in speaker boxes, audio jack modules, antennas, connectors (e.g. automotive connectors, DDR4 connectors) and splitters.

Thermoplastic molding compositions are used to be shaped into molded parts for a wide range of applications. Typically, such compositions are reinforced by reinforcing fibers to increase the mechanical properties, such as tensile modulus, tensile strength, elongation at break, flexural strength, flexural break and impact resistance, of the molded parts. For the reinforcing fibers, generally glass fibers, carbon fibers, or a combination thereof are used. Of these, glass fibers are most widely employed. The glass fibers are mostly of the type of E-glass. A problem with such reinforced compositions is that it can be difficult to obtain the right balance in properties, often the modulus and strength can be increased, e.g. by increasing the amount of glass fibers, but this might be at the cost of the elongation at break and impact resistance. On the other hand, the elongation at break and impact resistance may be increased by adding an impact modifier, but this might be at the cost of tensile strength and other properties, such as chemical resistance. Alternative approaches to improve the properties is the use of glass fibers with different shapes, such as flat glass fibers and glass fibers with an oblong cross section. Furthermore, the effectiveness of glass fibers as reinforcing agent can be reduced by the presence of, for example, abrasive components, such as titanium dioxide and laser direct structuring (LDS) additives.

The aim of the present invention is to provide a thermoplastic molding composition comprising a thermoplastic polymer and reinforcing fibers, which has good mechanical properties, in particular a high elongation in combination with good impact properties and a good tensile strength, and preferably high elongation and high impact properties in combination with a good tensile strength.

This aim has been achieved with the composition according to the invention, comprising
(i) a thermoplastic polymer selected from the group consisting of polyesters (PES), polyamides (PA), polycarbonates (PC), polyphenylene sulphides (PPS), polyphenylene ethers (PPO), polyaryletherketones (PAEK), polyetheretherketones (PEEK), polyamidimides (PAI), polyetherimides (PEI) and liquid crystal polymers (LCPs), and combinations thereof;
(ii) at least 22 wt. % of silicon-boron glass fibers comprising predominantly silicon dioxide (SiO₂) and boron trioxide (B₂O₃); and
(iii) 0-7 wt. % of halogen free flame retardant,
wherein the weight percentages (wt. %) are relative to the total weight of the composition.

The effect of the composition according to the invention is that the tensile elongation has increased, with retention of the tensile strength in large extent, compared to corresponding compositions comprising E-glass based reinforcing fibers; and often the impact resistance has improved too.

The composition according to the invention may comprise E-glass fibers, next to the silicon-boron glass fibers. The advantage of such compositions is that the tensile elongation is better, compared to corresponding compositions with the same amount of glass fibers fully consisting of E-glass fibers. Preferably, E-glass fibers, if present at all, are present in an amount of at most 30 wt. %, preferably at most 15 wt. %, relative to the weight of the silicon-boron glass fibers.

The composition comprises a thermoplastic polymer selected from the group consisting of polyesters (PES), polyamides (PA), polycarbonates (PC), polyphenylene sulphides (PPS), polyphenylene ethers (PPO), polyaryletherketones (PAEK), polyetheretherketones (PEEK), polyamidimides (PAI), polyetherimides (PEI) and liquid crystal polymers (LCPs), and combinations thereof. This group is referred to herein as group (i). Suitably, the thermoplastic polymer is a semi-crystalline polymer or an amorphous polymer, or a combination thereof. Examples of amorphous polymers are polycarbonates and amorphous semi-aromatic polyamides. Examples of semi-crystalline polymers are semi-crystalline polyesters, aliphatic polyamides and semi-crystalline semi-aromatic polyamides.

By “fiber” is herein understood an elongated body having dimensions of a length, a width and a thickness, with the length dimension of said body being much greater than the transverse dimensions of width and thickness. With the term ‘width’ is herein understood the largest dimension measured on a cross-section in transverse direction, and with the term thickness is herein understood the smallest dimension measured on a cross-section in transverse direction. The fibers may have various cross-sections, with a circular shape, or an irregular shape (i.e. non-circular shape with different width and thickness), e.g. a bean-shape, an oval shape, an oblong shape or a rectangular shape, with a greater width than thickness. More particular, the fibers in the composition according to the present invention suitably have an aspect ratio, defined by the ratio of length/width (L/W) of at least 10. In a particular embodiment, the glass fibers have a number average aspect ratio L/W of at least 20. The fibers may also have a cross section with varying dimensions. Suitably the fibers have a circular cross section with a diameter in the range of 5-20 μm, more particular 7-15 μm, for example 8 μm, or 10 μm or 13 μm. Alternatively, the fibers have a non-circular cross section with a width in the range of 5-30 μm, more particular 7-20 μm, for example 8 μm, or 10 μm, or 13 μm, or 15 μm.

With the term “thermoplastic” in thermoplastic polymer is herein understood a semi-crystalline polymer having a melting temperature (Tm) in the range of 200° C.-360° C., or an amorphous polymer having a glass transition temperature (Tg) in the range of 140° C.-300° C. The effect thereof is that the composition can be prepared by a melt mixing process and that the composition can be melt-processed for making molded parts.

With the term “semi-crystalline” in semi-crystalline polyamide and semi-crystalline polyester is herein understood that the polyamide or polyester has a melting temperature (Tm) and a melting enthalpy (ΔHm), as well as a glass transition temperature (Tg). Herein the semi-crystalline polyamide, as well as the semi-crystalline polyester, has a melting enthalpy of at least 5 J/g, preferably at least 10 J/g, and even more preferably at least 25 J/g. Polymers having a melting enthalpy of less than 5 J/g are herein understood to be amorphous polymers.

With the term “melting enthalpy” (ΔHm) is herein understood the melting enthalpy, measured by the DSC method according to ISO-11357-1/3, 2011, on pre-dried samples in an N₂ atmosphere with heating and cooling rate of 20° C./min. Herein (ΔHm) has been calculated from the surface under the melting peak in the second heating cycle.

With the term “melting temperature” is herein understood the temperature, measured by the differential scanning calorimetry (DSC) method according to ISO-11357-1/3, 2011, on pre-dried samples, in an N₂ atmosphere with heating and cooling rate of 20° C./min. Herein Tm is the temperature from the peak value of the highest melting peak in the second heating cycle.

In a particular embodiment of the invention, the thermoplastic polymer comprises a polyamide or a semi-crystalline polyester, or a combination thereof. The polyamide can be a semi-crystalline polyamide or an amorphous polyamide, or a blend thereof.

The semi-crystalline polyester may be, for example polyethylene terephthalate (PET), polytrimethylene terephthalate (PTT), polybutylene terephthalate (PBT), polycyclohexyl terephthalate (PCT), polyethylene naphthanate (PEN), polytrimethylene naphthanate (PTN), polybutylene naphthanate (PBN) and polycyclohexyl naphthanate (PCN), and blends and copolymers thereof.

Semi-crystalline aliphatic polyamides are polyamides consisting of repeat units derived from aliphatic monomers, for example aliphatic lactams, or aliphatic diamines and aliphatic dicarboxylic acid, or a combination thereof. The semi-crystalline aliphatic polyamide may be, for example PA-6, PA-66, PA-6/66, PA-46, PA-410, PA-1010, PA-610, PA-11 and PA-12, and blends and copolymers thereof.

With the term semi-aromatic in semi-aromatic polyamide is herein understood that the polyamide is derived from a combination of monomers comprising aromatic monomers, i.e. monomers comprising an aromatic unit, and non-aromatic monomers, i.e. monomers not comprising an aromatic group.

Semi-aromatic polyamides are polyamides consisting of repeat units derived from a combination of aromatic monomers and aliphatic monomers. Aromatic monomers are monomers comprising an aromatic ring structure. Suitably, the semi-aromatic polyamide comprises repeat units derived from aromatic dicarboxylic acid and aliphatic diamine, or repeat units derived from aliphatic dicarboxylic acid and aromatic diamine, or a combination thereof. Examples of aromatic dicarboxylic acid are terephthalic acid, isophthalic acid and naphthalene dicarboxylic acid. Examples of aliphatic dicarboxylic acid are adipic acid and decanedioic acid (also known as sebacic acid). Examples of aromatic diamines are meta-xylylenediamine and para-xylylenediamine. The aliphatic diamines can be linear diamines, branched diamine and cycloaliphatic diamines. Linear aliphatic diamines are suitably linear alpha-omega C2-C36 diamines, preferably linear C4-C12 diamines, for example 1,4-diaminobutane, 1,5-diaminopentane, 1,6-diaminohexane, 1,8-diaminooctane, 1,9-diaminononane, 1,10-diaminodecane, and 1,12-diaminododecane.

Semi-crystalline semi-aromatic polyamides can be, for example PA-XT homopolymers, PA-XT/XI copolymers, PA-XT/YT copolymers, PA-XT/Y6 copolymers, PA-XT/YI/Z6, PA-XT/YI/Z10 and PA-XT/6 copolymers and blends and copolymers thereof, wherein X, Y and Z represent repeat units derived from a diamine, T represents repeat units derived from terephthalic acid, I represents repeat units derived from isophthalic acid, 6 in combination with a diamine, as in Y6 in PA-XT/Y6 and Z6 in PA-XT/YI/Z6, represents repeat units derived from adipic acid, and 6 standing alone, separate by a slash (/) from other monomeric units, as in PA-XT/6, represents repeat units derived from caprolactam. The diamines can in principle be any aliphatic diamine or combination of aliphatic diamine and aromatic diamine. Examples of semi-crystalline semi-aromatic polyamides are PA-6T/10T, PA-6T/61, PA-6T/46 and PA-6T/6, PA-6T/66 and PA-6T/61/66.

An example of an amorphous semi-aromatic polyamide is PA-61/6T. The composition according to the invention comprises glass fibers comprising predominantly silicon dioxide (SiO₂) and boron trioxide (B₂O₃), referred to herein as silicon-boron glass fibers. With the term “predominantly” in comprising predominantly is herein understood that the silicon dioxide (SiO₂) and boron trioxide (B₂O₃) are the main components in the glass fibers. The silicon-boron glass fibers may comprise further components, but such components, if present at all, are present in a combined amount less than each of the silicon dioxide and the boron dioxide. Suitably, the silicon-boron glass fibers comprise silicon dioxide and boron trioxide in a combined amount of at least 90 wt. %, relative to the weight of the silicon-boron glass fibers. In a particular embodiment, the silicon-boron glass fibers consist of (a) 65-85 wt. % SiO₂; (b) 15-30 wt. % B₂O₃; (c) 0-4 wt. % sodium oxide (Na₂O) or potassium oxide (K₂O), or a combination thereof; and (d) 0-4 wt. % other components. In a further embodiment, the silicon-boron glass fibers consist of: (a) 70-80 wt. % SiO₂; (b) 18-27 wt. % B₂O₃; (c) 0-3 wt. % Na₂O or K₂O, or a combination thereof; and (d) 0-3 wt. % other components. An example thereof is silicon-boron glass fibers consisting of: (a) 70-80 wt. % SiO₂; (b) 20-25 wt. % B₂O₃; (c) 0-2 wt. % Na₂O or K₂O, or a combination thereof; and (d) 0-2 wt. % other components. Herein the weight percentages (wt. %), i.e. the weight percentages of (a)-(d), are relative to the weight of the silicon-boron glass fibers.

The composition may comprise the thermoplastic polymer and reinforcing fibers in amounts varying over a wide range. Suitably, the composition comprises the thermoplastic polymer selected from the said group (i) the said group (i) in in an amount in the range of 30-90 wt. %, for example in an amount in the range of 35-80 wt. %, or 30-75 wt. %, more particular 40-70 wt. %.

In the embodiment wherein the thermoplastic polymer comprises a polyamide or a semi-crystalline polyester, or a combination thereof, the polyamide, or the polyester, or the combination thereof is suitably present in an amount of 30-90 wt. %, for example in an amount in the range of 35-80 wt. %, more particular 40-70 wt. %. In this embodiment, also one or more of the other selected thermoplastic polymers from said group (i) may be present. Suitably, the total amount of the polyamide, or the polyester, or the combination thereof, and the one or more of the other selected thermoplastic polymers from said group (i) remains in the range of 30-90 wt. %, for example in an amount in the range of 35-80 wt. %, more particular 40-70 wt. %. The amount of the thermoplastic polymer is, for example, 35 wt. %, 45 wt. %, 55 wt. %, 65 wt. % or 75 wt. %. Herein the weight percentages (wt. %) are relative to the total weight of the composition.

The reinforcing fibers in the composition may comprise next to the silicon-boron glass fibers, other reinforcing fibers such as carbon fibers and glass fibers different from the silicon-boron glass fibers. The reinforcing fibers may also consist or essentially so, of the silicon-boron glass fibers. The composition suitably comprises at least 22 wt. %, preferably at least 25 wt. %, more preferably at least 30 wt. % of glass fibers as reinforcing fibers. The glass fibers are suitably present in an amount of at most 70 wt. %, more particularly at most 60 wt. %. In one preferred embodiment, the composition comprises 22-70 wt. %, of glass fibers comprising at least 22 wt. % of the silicon-boron glass fibers. In another preferred embodiment, the silicon-boron glass fibers are present in an amount in the range of 25-70 wt. %, for example in the range of 30-60 wt. %. The amount of the silicon-boron glass fibers is, for example, 25 wt. %, 30 wt. %, 40 wt. %, 50 wt. % or 65 wt. %. Herein the weight percentages (wt. %) are relative to the total weight of the composition.

These embodiments for the glass fibers are suitably combined with any one of the selected thermoplastic polymers of group (i), or any combination thereof, and can also be combined with the embodiments wherein the thermoplastic polymer comprises a polyamide or a polyester, or a combination thereof.

The composition according to the invention may comprise, next to the thermoplastic polymer and the reinforcing fibers, one or more other components. As other components, any auxiliary additive suitably used in thermoplastic molding compositions may be used. Suitable additives include inorganic fillers, impact modifiers, stabilizers,—for example heat stabilizers, anti-oxidants and UV stabilizers—, flame retardants—halogen-containing flame retardants, halogen-free flame retardants—, plasticizers, conductive and/or anti-static agents, carbon black, lubricants and mold release agents, nucleating agents, crystallization accelerators, crystallization retarders, dyes and pigments, and any other auxiliary additives that may be used in thermoplastic molding compositions, and mixtures thereof.

These additives can be used in variable amounts. Nevertheless, it is preferred that these additives are present in a limited amount. In the composition according to the invention, the amount of halogen free flame retardant, if present at all, is at most 7 wt. %, relative to the total weight of the composition. Suitably, the amount of the halogen free flame retardant is 0-6 wt. %, for example 3 wt. %, 4 wt. % or 5 wt. %. The halogen free flame retardant can be any halogen free flame retardant. Preferably, the halogen free flame retardant is a metal phosphinate or a metal diphosphinate, or a mixture thereof. Suitably, said metal(di)phosphinate is a metal dialkylphosphinate. An example thereof is aluminium diethylphoshpinate.

With fillers are herein understood particulate materials, consisting of particles with a regular globular shape or irregular shapes, having dimensions of a length, a width and a thickness, and having an aspect ratio, defined by the ratio of length/width of less than 10. Suitably, the fillers have a number average aspect ratio of at most 5.

Examples of fillers that can suitably be used in the composition according to the invention include, but are not limited to, silica, metasilicates, alumina, talc, diatomaceous earth, clay, kaolin, quartz, glass, mica, titanium dioxide, molybdenum disulphide, gypsum, iron oxide, zinc oxide, montmorillonite, calcium carbonate, glass powder and glass beads.

Preferably, the composition further comprises at least one component selected from the group of polymeric impact modifiers, LDS additives, and titanium dioxide, or a combination thereof. It is noted that the terms “one or more” and “at least one” are herein meant to have the same meaning and can be used interchangeably.

Suitably, the composition comprises the polymeric impact modifier in an amount of 0.01-10 wt. %, preferably 0.01-5 wt. %. The advantage of the composition of the present invention is that less of the polymeric impact modifier is needed, while elongation at break and impact resistance are increased and meanwhile the tensile strength is better retained. By combining silicon-boron glass fibers and polymeric impact modifier, the balance between tensile strength and elongation at break and impact resistance can be further optimized.

The polymeric impact modifier in the composition according to the invention suitably is a rubber or an elastomer, for example an acrylic based polymer, a polyolefin based polymer, a styrenic polymer, a silicon based polymer, and combinations and functionalized modifications thereof. With a functionalized polymeric impact modifier is herein understood a impact modifier wherein the polymer comprises functional groups capable of reacting with amine end-groups or carboxylic end-groups in the polyamide. Examples of such functional groups are epoxy groups, anhydride groups and carboxylic acid groups. When a polymeric impact modifier without functional groups is used, the composition preferably comprises a compatibilizer.

Polymeric impact modifiers are described, for example, in Additives for Plastics Handbook, ed. J. Murphy, 2001 (ISBN=0080498612). Examples of functionalized polymers are functionalized semi-crystalline polyolefins, for example maleated (i.e. maleic anhydride-functionalized) polyethylenes, maleated polypropylenes and maleated ethylene-propylene copolymers (available as EXXELOR™ PO), acrylate-modified polyethylenes (available as SURLYN(R)), methacrylic acid-modified polyethylene, and acrylic acid-modified polyethylene (available as PRIMACOR(R)).

In another preferred embodiment, the composition does not comprise a polymeric impact modifier. The advantage is that the composition has improved mechanical properties, compared to corresponding compositions based on E-glass, without impairment of the chemical resistance connected to the polymeric impact modifier. Such a composition is advantageously applied in automotive under the hood applications.

The composition suitably comprises an LDS additive in an amount in the range of 0.1-15 wt. %, preferably 2-10 wt. %. The advantage of the composition of the present invention is that combination of an LDS additive with silicon-boron glass fibers, the composition has better mechanical properties in terms of tensile strength, elongation at break and impact resistance, despite the negative effect of the LDS additive on the mechanical properties.

Compositions comprising LDS additives are used for the production of molded parts wherein the molded parts also serve as a carrier for a conductive circuit. The conductive circuit is produced by a so-called laser direct structuring process, wherein the molded part is treated with a laser beam to produce an activated structure on the molded part, followed by metal plating of the molded part, thereby forming a conductive circuit having the pattern of the activated structure.

The invention also relates to a circuit carrier obtainable by laser direct structuring process, wherein the carrier is a molded part comprising, or made of a composition according to the invention, or a specific embodiment thereof. The LDS additive generally is a metal compound capable of being activated by electromagnetic radiation and thereby forming elemental metal nuclei. Examples of LDS additives, that can be used herein, are metal compounds and metal oxides comprising at least one of copper, antimony or tin, and mixed metal compounds, for example spinel based compounds. Such spinel based compound suitably contains copper, chromium, iron, cobalt, or nickel, or a mixture of two or more of the forgoing, and preferably comprises copper.

Examples of mixed metal oxides are oxides of at least tin and a second metal from one or more of antimony, bismuth, aluminium and molybedenum. Examples of copper compounds are copper salts, such as copper hydroxide, copper phosphate, copper sulfate, cuprous thiocyanate; or a combination thereof.

The LDS additive is suitably combined with a white pigment, for example titanium dioxide (TiO₂; which can be anastase or rutile, or a combination thereof), zinc oxide (ZnO), zinc sulfide (ZnS), barium sulphate (BaSO₄) and barium titanate (BaTiO₃).

The composition according to the invention, and the various embodiments thereof, suitably comprises titanium dioxide in an amount in the range of 0.1-15 wt. %, preferably 2-10 wt. %. Herein the titanium dioxide is present as a further component, next to the silicon-boron glass fibers and the thermoplastic polymer, for example as a white pigment. The advantage of the composition comprising a combination of titanium dioxide with silicon-boron glass fibers is that the composition has better mechanical properties in terms of tensile strength, elongation at break and impact resistance, despite the negative effect of titanium dioxide on the mechanical properties.

In a preferred embodiment, the composition comprises both an LDS additive and titanium dioxide. The advantage thereof is that the composition has even better LDS properties, while at the same time the composition has better mechanical properties than a corresponding composition comprising E-glass fibers instead of the silicon-boron glass fibers. E-glass fibers are most widely used, in thermoplastic molding compositions, and generally consist of silica (SiO₂, about 53 to 57 wt. %), alumina (Al₂O₃, about 12 to 15 wt. %) and calcium oxide (CaO) and magnesium oxide (MgO) (together about 22 to 26 wt. %), and smaller amounts of boron oxide (B₂O₃, about 5 to 8 wt. %) and other minor components (generally below 1 to 2 wt. %).

Such compositions comprising an LDS additive are advantageously applied in applications for integrated electronic devices. The combination with white pigments are in particular used in applications requiring light colors in combination with high elongation and impact resistance, and temperature resistance.

For the LDS applications, the thermoplastic polymer preferably comprises a semi-crystalline polymer with a melting temperature of at least 270° C., preferably at least 290° C., and even better at least 310° C. This has the advantage that the composition is better suited for use in a lead free soldering process. For such applications, compositions comprising a semi-crystalline semi-aromatic polyamide are the best candidates.

The composition according to the invention, and the various particular and preferred embodiments thereof, can be prepared by standard melt-mixing processes using standard melt-mixing equipment for preparing fiber reinforced thermoplastic molding compositions. The composition may be prepared, for example, in a twin-screw extruder or in a kneader.

The composition can be used for making molded parts. The molded parts can be made by standard melt processes, such as injection molding and extrusion.

The invention further relates to molded parts made of the composition according to the invention. Examples of such molded parts include, but are not limited to housings and frames for an electronic mobile device. The frame for an electronic mobile device can be, for example, an outer frame or a middle frame. The composition is also advantageously used in molded parts for use in electrical components in applications such as in speaker boxes, audio jack modules, antenna's, connectors and splitters. The connector part can be, for example, a part of an automotive connector or a DDR4 connector.

The invention is further illustrated with the following examples and comparative experiments.

### Materials

PA-1=Semi-crystalline semi-aromatic polyamide: PA-10T Tm 305° C.
PA-2=Aliphatic polyamide: PA-410, Tm 245° C.
PA-3=Amorphous polyamide: PA-61/6T
PA-4=Semi-crystalline semi-aromatic polyamide: PA-4T/6T/66, Tm 325° C.
PBT=semi-crystalline polyester, polybutylene terephtahale
GF-A=E-glass fibers (Ø 10 μm), standard grade for thermoplastic molding compositions
GF-B=silicon-boron glass fibers (Ø 10μm), (75 wt. % SiO₂; 22 wt. % B₂O₃; 3 wt. % other oxides)
MRA-1=Mould release agent: Ethylene acrylic acid copolymer (AC540A)
MRA-2=Pentaerythrityl tetrastearate
IM=polymeric impact modifier: chemically modified ethylene acrylate copolymer (Fusabond A560)
Filler=Mica
FR=Halogen free Flame retardant: Aluminium diethyl phosphinate
LDS=LDS additive: Copper chromite black spinel (Sheppard Black 1G)
Black pigment=Carbon black master batch, 20% in PA-6 (Cabot PA3785)
White pigment=zinc sulfide (ZnS)
PTFE=polytetrafluoroethylene (anti-dripping grade)

### Compounding

### Polyamide Compositions

Polyamide compositions were prepared on a twin-screw extruder, employing standard compounding conditions. The temperature of the extruded melt was typically about 350-360° C. After the melt compounding, the resulting melt was extruded into strands, cooled and cut into granules.

### Polyester Compositions

Polyester compositions were prepared on a twin-screw extruder, employing standard compounding conditions. The temperature of the extruded melt was typically about 250-260° C. After the melt compounding, the resulting melt was extruded into strands, cooled and cut into granules.

### Injection Molding—Preparation of Test Bars for Mechanical Testing

Dried granulate material was injection molded into a mold to form test bars conforming ISO 527 type 1A; the thickness of the test bars was 4 mm. The polyamide compositions were injection molded into appropriate test molds using a standard injection-molding machine. Test bars were prepared using either a single gated mold for standard test bars or a double-gated mold for production of test bars with a weld line, each gate located at an opposite end of the sample and causing the formation of a weld line, while applying the same conditions as for the standard test bars. The setting temperature of the T-melt in the injection-molding machine for the polyamide compositions of Examples I-V (EX I-V) and Comparative Experiments A-C (CE A-C) was about 320° C. and for compositions of Example VI (EX-VI) and Comparative Experiment D (CE-D) about 340° C.; the temperature of the mold was 120° C. The setting temperature of the T-melt in the injection-molding machine for the polyester compositions was about 260° C.; the temperature of the mold was 80° C.

### Testing

### Melting Temperature (Tm)

The measurements of the melting temperature (Tm) were carried out with a Mettler Toledo Star System (DSC) using a heating and cooling rate of 20° C./min. in an N₂ atmosphere. For the measurements a sample of about 5 mg pre-dried powdered polymer was used. The pre-drying was carried out at high vacuum, i.e. less than 50 mbar and a 130° C. during 16 hrs. The sample was heated from 0° C. to a temperature about 30° C. above the melting temperature at 20° C./min, immediately cooled to 0° C. at 20° C./min and subsequently heated to about 30° C. above the melting temperature again at 20° C./min. For the melting temperature (Tm) the peak value of the melting peak in the second heating cycle was determined, according to the method of ISO-11357-1/3, 2011.

### Tensile Properties

The tensile modulus (TM), the tensile strength (TS) and the elongation at break (EaB) were measured in a tensile test according to ISO 527/1 at 23° C., at a drawing speed of 5 mm/min.

### Flexural Properties

The flexural modulus (FM), the flexural strength (FS) and the flexural break (FB) were measured in a flexural test according to ISO 178, which are all Standard Test Methods for Flexural Properties) at 23° C., at a speed of 2 mm/min

### Impact Properties

Charpy notched impact resistance was tested by the method according to ISO179/1eA at 23° C.

Notched notched impact resistance was tested by the method according to ISO180/1A at 23° C.

The various compositions and test results have been listed in Tables 1-3.

TABLE 1
Compositions and mechanical properties for Examples
I-IV and Comparative Experiments A and B

| | CE-A | EX-I | EX-II | EX-III | CE-B | EX-IV |
|---|---|---|---|---|---|---|
| Composition (wt. %) | | | | | | |
| PA-1 | 14.94 | 14.94 | 17.94 | 14.94 | 11.94 | 11.94 |
| PA-2 | 34.86 | 34.86 | 41.86 | 34.86 | 27.86 | 27.86 |
| GF-A | 50 | | | 25 | 50 | |
| GF-B | | 50 | 40 | 25 | | 50 |
| MRA-1 | 0.2 | 0.2 | 0.2 | 0.2 | 0.2 | 0.2 |
| PTFE | | | | | 10 | 10 |
| Total | 100 | 100 | 100 | 100 | 100 | 100 |
| Properties | | | | | | |
| Tensile Strength (MPa) | 259 | 238 | 215 | 230 | 194 | 192 |
| Elongantion at break (%) | 2.87 | 3.88 | 4.11 | 3.61 | 2.4 | 2.58 |
| Charpy impact (Notched) (kJ/m2) | 16.39 | 17.04 | 17.36 | 16.77 | 14.51 | 16.07 |
| Izod impact (Notched) (kJ/m2) | 17.0 | 18.2 | 17.9 | 17.91 | 13.46 | 14 |
| Density (g/cm³) | 1.548 | 1.479 | 1.391 | 1.512 | | |

EX-I, II and III, all based on silicon-boron glass fibers have a comparable to slightly lower tensile strength (TS), compared to Comparative Experiment A (CE-A) based on regular glass fibers (E-glass), while showing a significantly higher elongation at break (EaB), and a higher impact strength , both for Charpy and Izod than CE-A. By replacing half of the glass fibers, as in EX-III, already a significant increase in EaB, compared to CE-A, is observed.

EX-I has a 4.5 wt. % lower density, EX-II has a 10% lower density; parts can be designed with thicker dimensions to compensate for reduced tensile strength while exhibiting much higher EaB, or with same dimensions and having much higher EaB, and better impact resistance.

Similar results are observed for the compositions Example IV based on silicon-boron glass fibers, and Comparative Experiments A based on regular glass fibers (E-glass), both comprising 10 wt. % of PTFE. The compositions do have lower mechanical properties than the corresponding compositions not comprising PTFE, however, EX-IV has the same tensile strength as CE-B, while having a higher EaB and impact resistance than CE-B.

TABLE 2
Compositions and mechanical properties for Example
V and Comparative Experiment C (LDS grades) and Example
VI and Comparative Experiment D (PPA grades)

| | CE-C | EX-V | CE-D | EX-VI |
|---|---|---|---|---|
| Composition (wt %) | | | | |
| PA-1 | 11.4 | 11.4 | | |
| PA-2 | 29.8 | 29.8 | | |
| PA-3 | 4.6 | 4.6 | | |
| PA-4 | | | 66.2 | 66.2 |
| GF-A | 35 | | 30 | |
| GF-B | | 35 | | 30 |
| Filler | 2 | 2 | | |
| FR | 5 | 5 | | |
| MRA-1 | 0.2 | 0.2 | 0.3 | 0.3 |
| LDS | 7 | 7 | | |
| IM | 5 | 5 | | |
| Black pigment | | | 3.5 | 3.5 |
| Total | 100 | 100 | 100 | 100 |
| Properties | | | | |
| Tensile Strength (MPa) | 99.44 | 103.01 | 162.18 | 189.42 |
| Elongation at break (%) | 2.28 | 2.58 | 1.77 | 2.47 |
| Flexural Strength (MPa) | 163 | 169 | 281 | 290 |
| Flexural deformation at break (%) | 2.4 | 2.7 | 2.9 | 3.3 |
| Charpy impact (Notched) | 4.46 | 4.78 | 8.34 | 12.2 |
| Izod impact (Notched) | 5.2 | 6.64 | 8.86 | 12.43 |

Comparative Experiment C and Example V and are both LDS grades, based on respectively regular glass fibers (E-glass) and silicon-boron glass fibers. The results show that EX-V has better properties than CE-C for all of TS, EaB, FS, FB and impact resistance.

Comparative Experiment D and Example VI and are both semi-aromatic polyamide compositions, based on respectively regular glass fibers (E-glass) and silicon-boron glass fibers. The results show that EX-VI has better properties than CE-D for all of TS, EaB, FS, FB and impact resistance.

TABLE 3
Compositions and mechanical properties for Examples VII-
VIII and Comparative Experiments E-F (all PBT grades)

| | CE-E | EX-VII | CE-F | EX-VIII |
|---|---|---|---|---|
| Composition (wt. %) | | | | |
| PBT | 66.75 | 66.75 | 56.75 | 56.75 |
| GF-A | 30 | | 40 | |
| GF-B | | 30 | | 40 |
| MRA-2 | 0.25 | 0.25 | 0.25 | 0.25 |
| White pigment | 3.00 | 3.00 | 3.00 | 3.00 |
| Total | 100 | 100 | 100 | 100 |
| Properties | | | | |
| Tensile Strength (MPa) | 138 | 140 | 152 | 153 |
| Elongation at break (%) | 3.32 | 3.47 | 2.76 | 2.92 |
| Charpy impact (Notched) (kJ/m2) | 9.42 | 10.47 | 9.9 | 11.7 |
| Izod impact (Notched) (kJ/m2) | 67.24 | 69.26 | 59.45 | 67.75 |

Comparative Experiment E and Example VII are both PBT grades with 30 wt. % glass fibers, based on respectively regular glass fibers (E-glass) and silicon-boron glass fibers. The results show that EX-VII has TS comparable to CE-E and has better properties than CE-E for TS, EaB and impact resistance.

Comparative Experiment F and Example VIII and are both PBT grades with 40 wt. % glass fibers, based on respectively regular glass fibers (E-glass) and silicon-boron glass fibers. The results show that EX-VIIII has TS comparable to CE-F and better properties than CE-F for TS, EaB and impact resistance.

1. Composition comprising a thermoplastic polymer and glass fibers, wherein the composition comprises
(i) a thermoplastic polymer selected from the group consisting of polyesters (PES), polyamides (PA), polycarbonates (PC), polyphenylene sulphides (PPS), polyphenylene ethers (PPO), polyetheretherketones (PEEK), polyaryletherketones (PAEK), polyamidimides (PAI), polyetherimides (PEI) and liquid crystal polymers (LCPs), and combinations thereof;
(ii) at least 22 wt. % of silicon-boron glass fibers comprising predominantly silicon dioxide (SiO₂) and boron trioxide (B₂O₃); and
(iii) 0-7 wt. % of halogen free flame retardant, wherein the weight percentages (wt. %) are relative to the total weight of the composition.

2. Composition according to claim 1, wherein the thermoplastic polymer comprises a polyamide or a semi-crystalline polyester, or a combination thereof.

3. Composition according to claim 1, wherein the silicon-boron glass fibers comprise silicon dioxide and boron trioxide in a combined amount of at least 90 wt. %, relative to the weight of the silicon-boron glass fibers.

4. Composition according to claim 3, wherein the silicon-boron glass fibers consist of: (a) 65-85 wt. % SiO₂; (b) 15-30 wt. % B₂O₃; (c) 0-4 wt. % sodium oxide (Na₂O) or potassium oxide (K₂O), or a combination thereof; and (d) 0-4 wt. % other components; wherein the weight percentages (wt. %) are relative to the weight of the silicon-boron glass fibers.

5. Composition according to claim 1, wherein the compositions comprises E-glass fibers in an amount of at most 30 wt. %, preferably at most 15 wt. %, relative to the weight of the silicon-boron glass fibers.

6. Composition according to claim 1, wherein the composition comprises:
a) 30-75 wt. % of the thermoplastic polymer of group (i);
b) 25-70 wt. % of the silicon-boron glass fibers; and
c) 0-7 wt. % of halogen free flame retardant,
wherein the weight percentages (wt. %) are relative to the total weight of the composition.

7. Composition according to claim 1, wherein the composition comprises:
a) 30-75 wt. % of polyamide or semi-crystalline polyester, or a combination thereof;
b) 25-70 wt. % of glass fibers comprising at least 22 wt. % of the silicon-boron glass fibers; and
c) 0-7 wt. % of halogen free flame retardant,
wherein the weight percentages (wt. %) are relative to the total weight of the composition.

8. Composition according to claim 1, wherein the composition comprises a polymeric impact modifier.

9. Composition according to claim 1, wherein the composition comprises a laser direct structuring (LDS) additive.

10. Composition according to claim 1, wherein the composition further comprises a white pigment comprising titanium dioxide.

11. Molded part comprising a composition of claim 1.

12. Use of a composition according to claim 1, or of a molded part comprising a composition, in a housing or a frame for an electronic mobile device.

13. Electronic mobile device comprising a housing or a frame, wherein the housing or frame is made of a composition according to claim 1.

14. Use of a composition according to claim 1, or of a molded part comprising a composition, in a part of speaker boxes, audio jack modules, antenna's or connectors.
